(19) United States
(12) Patent Application Publication
(10) Pub. No.: US 2002/0147770 A1
(43) Pub. Date: Oct. 10, 2002

(54) Multicast enabled caching service

(76) Inventor: Timothy Tang, Gaithersburg, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 09/934,013

(22) Filed: Aug. 21, 2001

Related U.S. Application Data
(60) Provisional application No. 60/285,376, filed on Apr. 20, 2001.
(60) Provisional application No. 60/282,437, filed on Apr. 9, 2001.

(51) Int. Cl. G06F 12/08

(52) U.S. Cl. 709/203; 711/137; 711/217

(57) ABSTRACT

An approach for providing intelligent caching is disclosed. A communications system includes a first caching logic that is configured to analyze a traffic stream for content and to output a first profile of the content. The system also includes a second caching logic that is configured to generate a second profile based upon the first profile, wherein the second profile is used to retrieve content. The content associated with the second profile may be pre-loaded into remote cache using multicasting over a wide area network (WAN), such as, a satellite network.

### RELATED APPLICATIONS

The present application is related to and claims the benefit of the earlier filing date of U.S. patent application (Attorney Docket Number: PD-201082), filed on Apr. 9, 2001 and entitled “Bacchus Multicast Enabled Intelligent Caching”, and U.S. patent application (Attorney Docket Number: PD-201095), filed on Apr. 20, 2001 and entitled “Bacchus Multicast Enabled Intelligent Caching”; the contents of which are hereby incorporated by reference.

### FIELD OF THE INVENTION

The present invention relates to data communications and more particularly to enhancing network performance through caching services.

### BACKGROUND OF THE INVENTION

The entrenchment of data networking into the routines of modern society, as evidenced by the prevalence of the Internet, particularly the World Wide Web (the “web”), has placed ever-growing demands on service providers to continually improve network performance. To meet this challenge, service providers have invested heavily in upgrading their networks to increase system capacity. In many circumstances, such upgrades may not be feasible economically or the physical constraints of the communications system do not permit simply “upgrading.”Accordingly, service providers have also invested in developing techniques to optimize the performance of their networks.

The popularity of the web stems largely from the fact that the end-user is supplied with rich, multimedia information; such information, which may be graphically intensive, consumes a tremendous amount of network resources (i.e., bandwidth), resulting in increased application response time. This delay is particularly acute over traditional low-speed connections (e.g., modem connection) of typical residential consumers. Further, the data exchange between a web browser and a remote web server (which supplies the content) may introduce additional delay because of the constraints or limitations of the communications protocol. Such delay is characteristic of the popular TCP/IP (Transmission Control Protocol/Internet Protocol) stack, which has emerged as the industry internetworking standard. For example, TCP requires the establishment and tear-down of numerous communication connections relating to a single transaction (e.g., a HTTP (HyperText Transfer Protocol) GET message), translating to network latency. The Internet suffers from numerous deficiencies including packet loss, queuing delays due to congestion and security threats. The above considerations provide an impediment to network performance.

One approach to combating poor network performance has been to employ a cache to capture content that has been recently requested by the end-user, thereby avoiding the delay that accompanies retrieving the requested information over a slow Internet access line and over the Internet itself. Under conventional caching operation, as content is being requested, a copy is stored in the local cache when the content is retrieved. When a subsequent request for the same content is made, instead of sending the request across the Internet to the web server, the content is obtained from the local cache. One drawback of this caching approach is that the content needs to be first loaded into the cache to realize any performance benefit. In other words, no performance advantage is achieved the first time a request is made, as the content is not within the local cache (i.e., cache miss). When the latencies associated with a cache miss are fully factored in the delay, the performance of this caching scheme may actually be worse. Similarly, when the content expires, the local cache is re-loaded without any performance gain.

Based on the foregoing, there is a clear need for improved approaches to optimizing network performance. There is also a need to enhance network performance, without a costly infrastructure investment. There is also a need to employ a network performance enhancing mechanism that complies with existing standards and techniques to facilitate rapid deployment. Therefore, an approach for optimizing network performance using a caching mechanism that provides performance gains throughout the caching process is highly desirable.

### SUMMARY OF THE INVENTION

These and other needs are addressed by the present invention in which a caching mechanism includes a master cache that distributes a content that is derived from a master profile to one or more remote cache engines. Each of the remote cache engines provides analysis of the content that is accessed by the particular cache engine; the analysis, in turn, is sent to the master cache. In an exemplary embodiment, the analysis is used to order the content according to the degree of popularity. The master cache, in turn, conducts an analysis of the contents from all of the remote cache engines to generate the master profile. According to one embodiment of the present invention, the content associated with the master profile is pre-loaded in the remote cache engines using multicast over a satellite network.

In one aspect of the present invention, a method for providing intelligent caching is disclosed. The method includes analyzing a traffic stream for content. The method also includes outputting a profile of the content based upon the analyzing step, wherein the profile is used to prepare a master profile. The method further includes caching content that is associated with the master profile.

In another aspect of the present invention, a method for providing intelligent caching is disclosed. The method includes receiving a profile that is prepared based upon content of a traffic stream. Additionally, the method includes generating a master profile based upon the received profile, and transmitting content associated with the master profile to a remote cache.

In another aspect of the present invention, a communications system for providing intelligent caching is disclosed. The system includes a first caching logic that is configured to analyze a traffic stream for content and to output a first profile of the content. The system also includes a second caching logic that is configured to generate a second profile based upon the first profile, wherein the second profile is used to retrieve content.

In another aspect of the present invention, a network device for providing intelligent caching services is disclosed. The device includes a processor that is configured to analyze a traffic stream for content and to output a profile of the content, wherein the profile is used to prepare a master profile. The device also includes a cache that is coupled to the processor and configured to store content that is associated with the master profile.

In another aspect of the present invention, a network device for providing intelligent caching is disclosed. The device includes a communications interface that is configured to receive a profile that is prepared based upon content of a traffic stream. The device also includes a processor that is coupled to the communications interface and configured to generate a master profile based upon the received profile. The content associated with the master profile is transmitted over the communications interface to a remote cache.

In another aspect of the present invention, a network apparatus for providing intelligent caching is disclosed. The apparatus includes means for analyzing a traffic stream for content; means for outputting a profile of the content, wherein the profile is used to prepare a master profile; and means for caching content that is associated with the master profile.

In another aspect of the present invention, a computer-readable medium carrying one or more sequences of one or more instructions for providing intelligent caching is disclosed. The one or more sequences of one or more instructions include instructions which, when executed by one or more processors, cause the one or more processors to perform the step of analyzing a traffic stream for content. Another step includes outputting a profile of the content based upon the analyzing step, wherein the profile is used to prepare a master profile. Yet another step includes caching content that is associated with the master profile.

In another aspect of the present invention, a computer-readable medium carrying one or more sequences of one or more instructions for providing intelligent caching is disclosed. The one or more sequences of one or more instructions include instructions which, when executed by one or more processors, cause the one or more processors to perform the step of receiving a profile that is prepared based upon content of a traffic stream. Another step includes generating a master profile based upon the received profile. Yet another step includes transmitting content associated with the master profile to a remote cache.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a communications system including a master cache and remote caching engine, according to an embodiment of the present invention;

FIG. 2 is a flow diagram of a process for performing intelligent caching in the system of FIG. 1;

FIG. 3 is a flow diagram of a process for performing content popularity analysis in the caching engine in the system of FIG. 1;

FIG. 4 is a flow diagram of a process for performing content popularity analysis in the master cache in the system of FIG. 1;

FIG. 5 is a diagram of a communications system including a master cache that is configured to perform content popular analysis of multiple remote caching engines, according to an embodiment of the present invention;

FIG. 6 is a diagram of an exemplary two-tiered content analysis utilizing categorization of content communities, according to an embodiment of the present invention; and

FIG. 7 is a diagram of a computer system that can be used to implement an embodiment of the present invention.

### DESCRIPTION OF THE PREFERRED EMBODIMENT

In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the present invention is discussed with respect to the Internet and a satellite network to access the Internet, the present invention has applicability to other data networks and access communications systems.

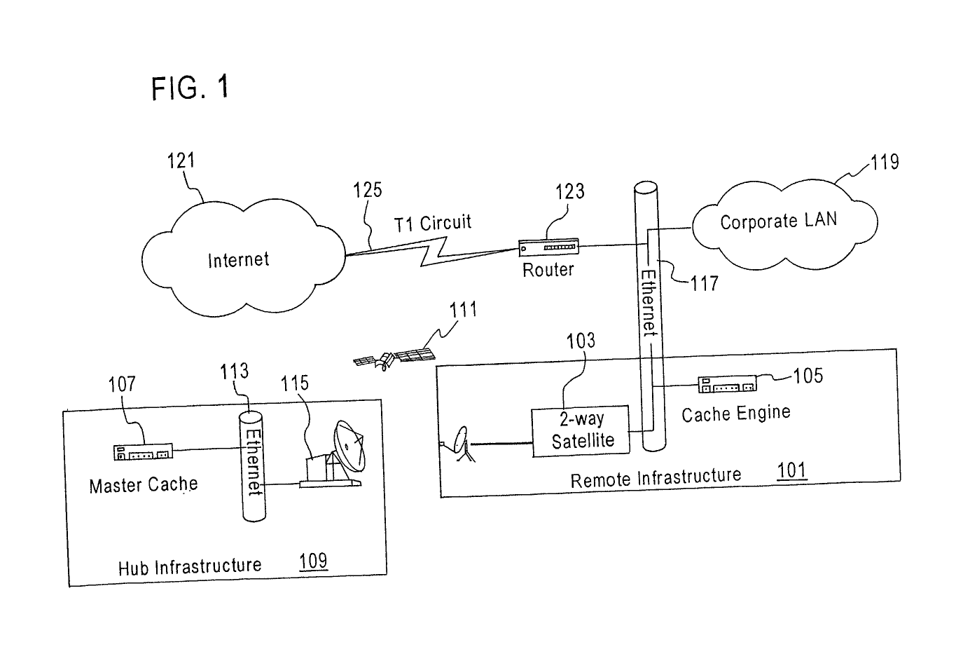

FIG. 1 shows a diagram of a communications system including a master cache and remote caching engine, according to an embodiment of the present invention. The system 100 provides caching services, which seek to achieve a higher cache hit rate by intelligently pre-loading the cache with known popular content. A customer location 101, or remote infrastructure, is equipped with a two-way satellite overlay 103 and a cache engine 105. According to one embodiment of the present invention, the cache engine 105 includes logic and a storage medium (e,g. hard drive, memory, etc.) to perform the caching services; alternatively, the storage medium that is separate from the cache engine may be utilized. The two-way satellite overlay 103, in an exemplary embodiment, is a satellite terminal that facilitates communication between the cache engine 105 and a master cache 107 within a hub infrastructure 109 over a satellite 111. Similar to the cache engine 105, the master cache 107 may include logic and a storage medium for performing the caching services of the present invention. The hub infrastructure 109 has a local area network (LAN) 113, which may be Ethernet, to provide connectivity between the master cache 107 and a satellite terminal 115. The function of the master cache 107 is later described.

As shown, the remote infrastructure 101 includes a LAN 117 to which the two-way satellite terminal 103 and the cache engine 105 are attached. The LAN 117, in an exemplary embodiment, is an Ethernet LAN and connects to another LAN 119 (e.g., a corporate LAN) and the internet 121. Specifically, Internet access is supported by a router 123, which connects to an Internet Service Provider (ISP) (not shown) over a high speed connection 125 (e.g., T1 circuit). It is recognized that the connection 125 may be in any format or rate, as supported by the ISP.

The caching services of the system 100 essentially involve deployment of a two-way satellite overlay combined with a caching appliance (i.e., cache engine 105) running the caching process of the present invention. The remote cache engine 105 is deployed at the customer remote locations 101 and, among other functions, provides normal caching capabilities, which is now described. Under normal caching, as end-user hosts request various content, the remote cache engine 105 checks to determine whether the content resides in the cache 105. If the requested content is stored within the cache 105, the content is delivered from the remote cache engine 105 to the requesting host (not shown). If there is a cache miss (i.e., the content is not stored within the cache 105), the content request is redirected out the Internet connection 125. When the requested piece of content is delivered, a copy is store in the remote cache engine 105 in anticipation for future request. A typical cache monitors the browser activity of the remote pool of users. As content is being requested, a copy is stored in the local cache. When subsequent request for the same piece of content is made, instead of going out to the Internet, the content is distributed from the remote cache. Cached content is not only delivered faster, but because the content is delivered from a local source, it is not necessary to consume Internet bandwidth to download the content.

The main drawback with the conventional caching techniques is that content needs to be first loaded into the remote cache in order for any benefits to be realized. In other words, the first time a site request a particular piece of content, there is no performance advantage to the remote cache. When the latencies associated with a cache miss are considered, the performance of a normal cache is actually worse. Similarly, when the content expires, the remote cache must be re-loaded in the same mundane fashion.

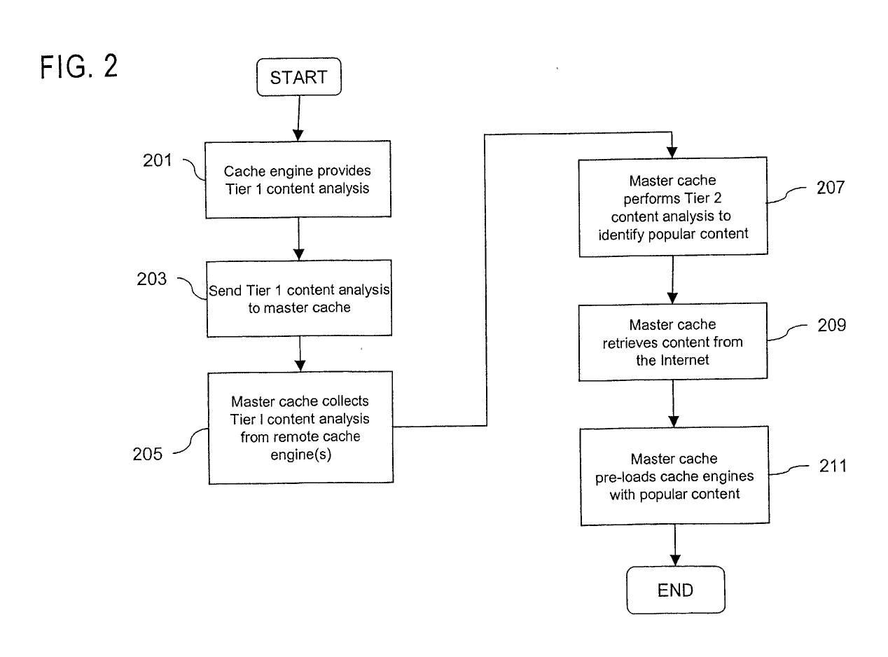

According to one embodiment of the present invention, the enhanced caching services of the system 100 combine the inherent efficiencies of multicast distribution with intelligent analysis to proactively load/refresh remote caches with popular content before a user at the location has issued a request. Given the narrower spectrum of content found, for example, in the corporate use of the public Internet 121, the caching services are especially effective in optimizing corporate Internet access. These caching services are described below with respect to FIGS. 2-4.

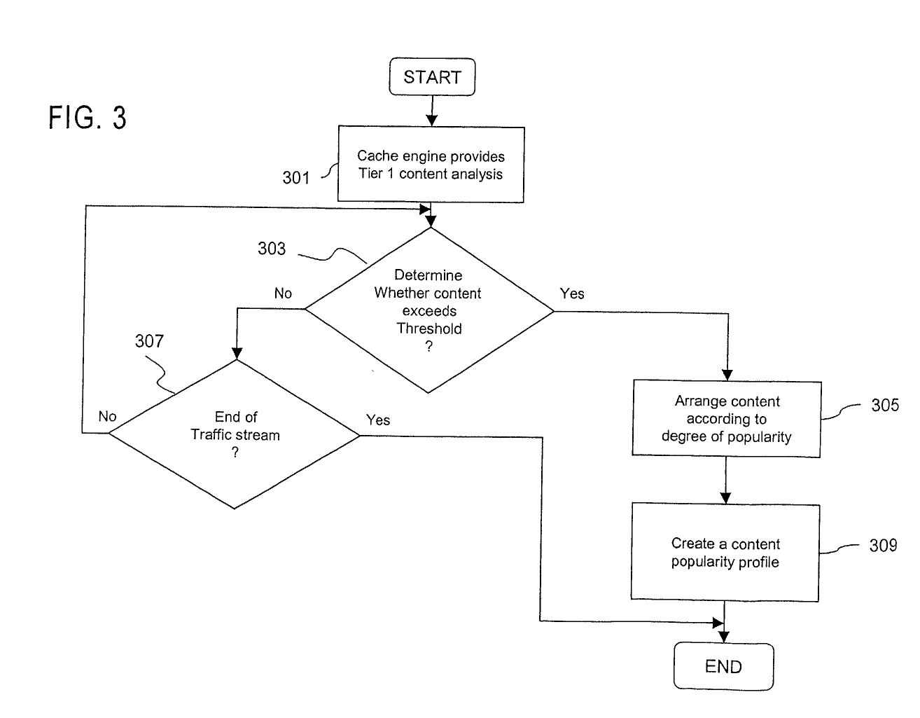

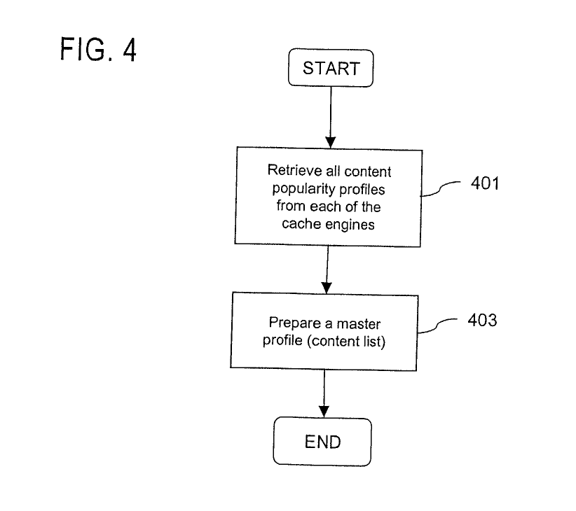

FIG. 2 shows a flow diagram of a process for performing intelligent caching in the system of FIG. 1. In step 201, the cache engine 105, in addition to providing all of the standard capabilities of a conventional cache, provides a first level (or Tier 1) content analysis, according to one embodiment of the present invention. The Tier 1 content analysis provides a profile of the content that is analyzed from a traffic stream; the profile may be ordered according to popularity as more fully described in FIG. 3. The results of this analysis, as in step 203, are returned to the master cache 107, which collects Tier 1 content analysis from the entire population of remote users (of which only one remote infrastructure 101 is shown) (step 205). The master cache 107 also conducts a second level (i.e., Tier 2) content analysis to identify popular content at a global level, per step 207. This Tier 2 analysis is detailed later in FIG. 4. The master cache 107 then retrieves the content from the Internet 121, as in step 209, and multicast the content across the two-satellite overlay in order to pre-load cache engines with popular content (step 211).

The system 100 provides a content catalog system that identifies the nature of the content which will allow the remote cache engines 105 to understand which pieces of content ought to be saved to the local cache and which pieces of content ought to be simply ignored. The master cache 107 maintains the “freshness” of the popular content that is preloaded in the remote caches 105. As content expires, the master cache 107 proactively refreshes the content by re-multicasting the content out to the remote cache engines 105. As mentioned, FIG. 3 below describes the Tier 1 analysis process.

FIG. 3 shows a flow diagram of a process for performing content popularity analysis in the caching engine in the system of FIG. 1. The remote cache engine 105 analyzes the traffic stream for popular content, per step 301. Next, the cache engine 105, as in step 303, determines whether the content exceeds a predetermined threshold, denoted as a “popularity threshold.” If the threshold is exceeded, the content is entered into a list that identifies the content and its degree of popularity (i.e. number of hits), per step 305. The list or profile may specify, in an exemplary embodiment, the URLs (Uniform Resource Locators) where the content may be retrieved. However, if the content fails to meet the threshold, then the cache engine 105 determines if all the content has been examined, as in step 309. If there is more content to examine, then step 303 is repeated. In step 309, a content popularity profile for all the Internet content that have been requested by users at the remote location is created. The content popularity profile organizes content from the most popular content to the least popular content; this may be determined from, for example, the number of hits to the web sites. This list of popular content is to be transmitted to the master cache 107 at defined intervals (e.g., once/hour) or as triggered by certain events (e.g., when the list changes by more than 10%).

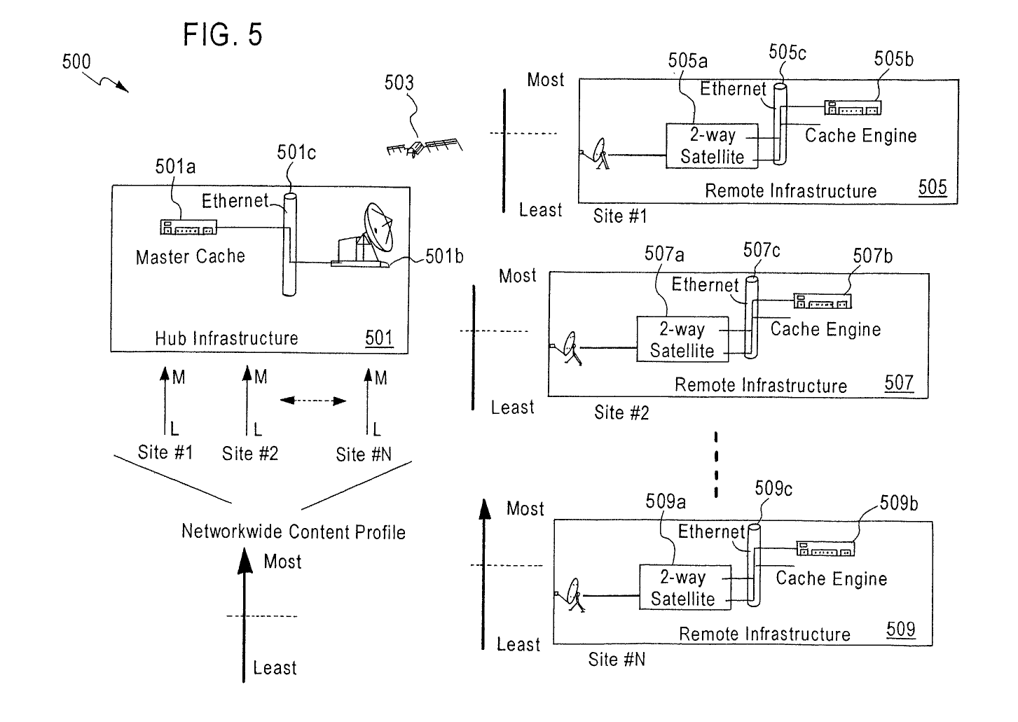

FIG. 4 shows a flow diagram of a process for performing content popularity analysis in the master cache in the system of FIG. 1. Assuming multiple cache engines are deployed in the system 100 (as in FIG. 5), the master cache 107, as in step 401, retrieves all the content popularity profiles from each of the cache engines (e.g., cache engine 105). After this data collection, the master cache 107 prepares a master profile (or master content list). Based upon the master profile, the master cache 107 may instruct a web crawler application, for example, to retrieve the content from the various web servers over the Internet 121. As more fully described below, this content associated with this master profile is then pre-loaded into the remote cache engine 105.

FIG. 5 shows a diagram of a communications system including a master cache configured to perform content popular analysis of multiple remote caching engines, according to an embodiment of the present invention. Similar to the system of FIG. 1, the system 500 provides a hub infrastructure 501 (i.e., satellite hub) that includes a master cache 501a that is attached to satellite terminal 501b via a LAN 501c. The satellite hub 501 exchange data packets over a satellite 503 to various remote locations (or infrastructures) 505, 507, 509. Each of the remote locations 505, 507, 509 includes a two-way satellite overlay 505a, 507a, 509a with connectivity to a cache engine 505b, 507b, 509b, in which the connectivity is supported by a LAN 505c, 507c, 509c. In this example, N number of remote locations 505, 507, 509 are supported by the satellite hub 501.

As previously described, at the satellite hub 501, the master cache 501 collects the Tier 1 “popular” content list from the entire population of remote cache engines 505b, 507b, 509b. The Tier 1 content list is aggregated into a master content list and analyzed for content that is popular across the entire network as a Tier 2 content list. This Tier 2 content list defines content to be pre-loaded into the remote cache engines 505b, 507b, 509b. In an exemplary embodiment, the content may be pre-loaded into the remote caches 505b, 507b, 509b via satellite multicast distribution.

The master cache 501 is responsible for maintaining the “freshness” of the content that is specified in the Tier 2 popular content profile (or list). That is, as the content expires or becomes stale, the master cache 501 automatically retrieves a fresh copy of the content and re-broadcasts this content out to the appropriate remote caches 505b, 507b, 509b. The expiration may be implemented using a timer with a configurable duration; alternatively, the expiration of the timer may be triggered by an event. The master cache may proactively trickle content to accommodate the need to pre-load into a new cache installed in the network.

Given the high volume of content, which may be distributed over the satellite overlay network, and the finite amount of available bandwidth, the system 500 may prioritize the transmission of the content to optimize network performance. The content may be ordered for transmission according to a popularity factor (PopF), which is proportional to the content's popularity, such that content with greater popularity is transmitted ahead of content with lesser popularity.

From a transport perspective, the ideal characterization of content is that content that is small in size and long in expiration window. Such content requires minimal transport bandwidth capacity. The transport of “Large-sized” content naturally requires large amounts of bandwidth for transmission across the satellite overlay network. Similarly, content that has a short expiration window requires larger amounts of bandwidth capacity to support extremely frequent retransmissions, which are required to maintain content freshness. In order to make optimum use of the space segment capacity, the system 500 minimizes the scenarios, which require extreme amounts of bandwidth for relatively minimal improvement in cache hit rates.

A variable, denoted as a Caching Factor (CF), is used to adjust the content's priority for transmission across the satellite network. The CF is defined as follows:

CF=T/S*C,

Where T is the time until expiration, S is the size of the file (e.g., in Megabytes), and C is the adjustment constant. Content with extremely short expiration time has a small Caching Factor. Extremely large pieces of content similarly have a short expiration factor. The value of the adjustment constant, C, is used to tune the prioritization of content with extreme characterization (i.e., very large size, very small expiration window) as compared to the content with ideal characterization (i.e., small size, large expiration window).

Further, a Prioritization constant (P) is defined to enable service operators of the satellite network to manually influence the transmission priority of specific types of content. For example, it may be more important for a customer to have Intranet content distributed ahead of Internet content. In such a case, the Intranet content would be assigned a higher prioritization factor than the Internet content. As another example, it may be more important to a customer to have a multimedia clip of a speech by an executive of the company prioritize for immediate distribution. In such a case, the multimedia clip would be assigned a higher prioritization factor. This prioritization mechanism makes possible other classes of services that are available to the end user. For example, a “Gold Level” customer paying higher premiums than “Silver Level” Customer will have their content distributed ahead of the lower priority customers. Such behavior is achieved by manually increasing the prioritization constant.

An Overall Transmission Priority (OTP) may be defined as follows:

OTP=PopF*CF*P,

Where PopF is the Popularity Factor, and P is the Prioritization constant. As mentioned above, the transmission priority determines the order in which content is transmitted across the space link to be pre-loaded into the remote caches 505b, 507b, 509b. Content prioritization methodology may be tuned to achieve the highest possible cache hit rate.

With the above prioritization mechanism, a number of rules may be specified for the transmission of the content. For example, content that has already expired in remote caches ahead of new content, which has never been downloaded, are transmitted ahead of normal content. Content from “specified” web site may be prioritized ahead of general traffic by tuning “specified” content with a higher prioritization constant than general traffic. Under this prioritization approach, content with extremely high popularity still receives the higher priority for transmission across the space link. However, content requiring unusually large amounts of bandwidth (due to large file size or short expiration window) are reduced in prioritization by the Caching Factor. Such compensation ensures that the intelligent caching service does not expend bandwidth sending bandwidth intensive pieces of content, when the broadcast of other content would actually achieve overall higher hit rates across the system 500.

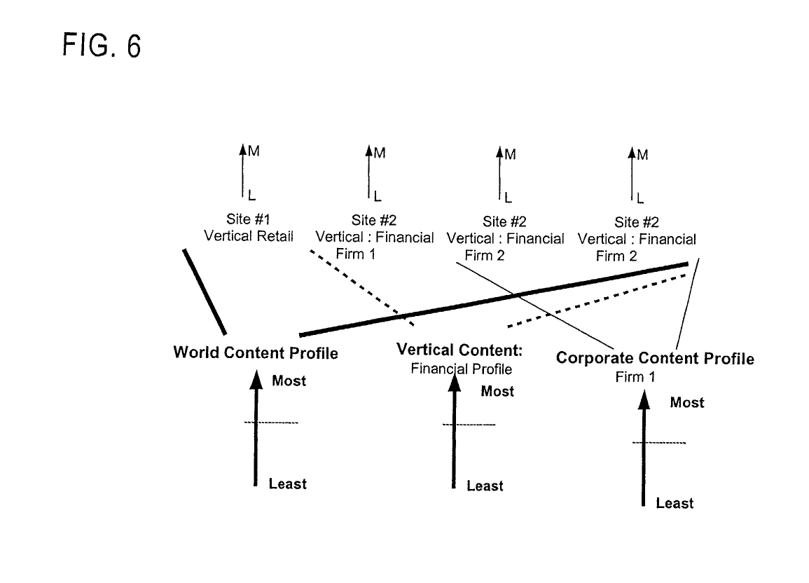

In order to make optimal use of the remote cache engine's resources, such as memory and/or hard drive space, each location can be categorized into communities of content interest. The categorization enables remote engines 505b, 507b, 509b to identify the content that should be pre-loaded and those content that should be ignored. For example, four levels of categorization, World, Vertical Industry, Corporate, and Site specific, may be employed, as shown in FIG. 6.

FIG. 6 shows a diagram of an exemplary two-tiered content analysis utilizing categorization of content communities, according to an embodiment of the present invention. When each remote cache engines 505b, 507b, 509b submits its Tier 1 list of popular content to the master cache 501a, the remote cache engine 505b, 507b, 509b identifies itself according to a content categorization IDs (identification) (e.g., Vertical Industry ID, Corporate ID, etc.) When the master cache 501a conducts its Tier 2 analysis for content to be distributed, the master cache 501a identifies content for distribution according to these categorization schemes. The master cache 501a collects Tier 1 content profiles from all the remote locations in the publishers industry, which in this example is the financial industry, and analyzes these lists for “publisher” specific popular content.

Each remote cache engine 505b, 507b, 509b, in an exemplary embodiment, has the capability to receive transmission across multiple multicast address. For example, the first address is associated with content at the “World Category” level. This multicast address is used by all locations in the system 500. The second address is used to transmit content at the vertical industry level; this multicast address is used by all locations within a particular vertical industry. The third multicast address is used to transmit content at the corporate level and is used by all locations within a particular corporation. Additional categorizations may be added as appropriate Site specific content is distributed on a point-to-point basis, using, for example, unicast transmission.

When the master cache 501 distributes “publisher” specific content, only those remote cache engines 505b, 507b, 509b in the “publishers” content community are pre-loaded with the “publisher” popular content. The caches associated with other industries (e.g., Consulting and Biotechnology) ignore the “publisher” popular content. Distributions may also be encrypted for security purposes; for example, Private Intranet content may only be distributed to those caches belonging to the specific corporation.

The remote cache engines 505b, 507b, 509b, in an exemplary embodiment, utilize a non-volatile storage medium, such as a hard drive to store the cache content (i.e., content profile). Because the amount of hard drive space is fixed, the remote engines 505b, 507b, 509b strategically allocate partitions for content categories according to the content profiles of the users at the remote location to maximize performance. The size of the partitions is set to match the content needs of the remote users. For example, for those remote locations that use the Internet for predominantly Corporate Intranet applications, a majority of the remote's hard drive space can be allocated for Corporate specific content. The other categories (World, Vertical, Corporate, Site Specific) share equally the remaining portions of the hard drive.

Furthermore, another remote location may have predominantly Vertical Industry needs. For example, a financial company many use the Internet 121 primarily for market research. In this scenario perhaps half of the local hard drive may be partitioned for Vertical content, while the other half of the hard drive is partitioned among Intranet content, World content, and Site Specific Content. It is noted that the partitions of the hard drive may be statically defined or adjusted on a dynamic basis. In other words, the remote engines 505b, 507b, 509b may dynamically adjust the size of the partition to achieve the highest possible hit rate.

Multi-partition content overlap may exist, given the capability to customize the partitions. For example, the “World” popularity content may overlap with that of the “Vertical” content. To minimize utilization of the hard drive space, a remote engine may maintain only one copy of the specified content; in an exemplary embodiment, the copy in the more encompassing category partition is preserved.

The system 500 (of FIG. 5) provides a Network Management System (not shown) to collect statistics, which may be used for monthly customer reports, for instance. According to one embodiment of the present invention, the statistics may include the following: overall achieved cache hit rate for each location; Internet access bandwidth utilization—effectiveness of the cache engine in reducing bandwidth requirements; volume data transmitted to each locations—excessive content distribution may required additional fees; the most popular content for the customer; and content usage information—enables monitoring of Internet usage by employees. It is noted that content usage statistics that are collected at the master cache 501 may also be used for billing purposes. The network management system of the system 500 may be provided as a managed service by the service provider, thereby advantageously eliminating such a management burden from the customer.

Content usage statistics are helpful in reducing Internet access at the remote locations. From a corporate perspective, it is in the best interest of the company to restrict employee usage of the Internet for business purposes only; otherwise, employees may saturate a valuable corporate resource for private purposes. Traditionally, many corporations are trapped between two alternatives with respect to Internet access policies. The first approach strictly limits an employee to view only a specified list of sites. For example, a financial institution may choose to allow brokers to view the corporate Intranet site and other popular financial content web sites. One drawback with this approach is that it does not provide the flexibility to allow employees to broad access to Internet content, which may be relevant to their business activities (but has not yet made the list of permissible sites to visit). As a result, the access policy interferes with the employees' ability to do their job.

The second approach provides broad access to the Internet 121 without any restriction. Although this approach permits the employee the opportunity to access any Internet content (which may or may not be relevant to their corporate responsibilities), the approach has the drawback that valuable corporate resources may be wasted if the employee engages in personal Internet activities (e.g., surfing, gaming, etc.).

The caching services of the system 500 provide the customer (e.g., corporation) with the capability to permit users (i.e., employees) to have the freedom to access any content that is work-related, yet at the same time supporting reduction of personal activities that burden the corporate's Internet access resources. The system 500 has a comprehensive reporting capability, such as a content usage report. Frequent usage of business related content, indicates employee Internet access usage are aligned with the corporation's goals. Frequent usage of personal content indicates employee Internet access abuse. The prevent such abuse, a corporate IT (information technology) manager may selectively choose to block those content which experience high volume usage, but yet have nothing to do with the business of the company. The IT manager may submit a black list of URLs (Uniform Resource Locator), for instance, to the network operations center (NOC) of the system 500. Accordingly, the remote cache engines 505b, 507b, 509b are configured to block any end-user request to black listed URLs. In some cases, such selective blocking results in dramatic reductions in bandwidth utilization. Under the above arrangement according to an embodiment of the present invention, the user has the full potential of the Internet to assist in their daily work efforts, and yet is prevented from regular abuse of corporate resources.

The Internet access management capabilities of the system 500 empowers the customer (e.g., corporate enterprise) to provide open access to the Internet 121, yet block popular personal content which burdens the Internet Access resources. This capability may also be the vehicle to limit corporate exposure to employee rights violations by proactively eliminating enterprise Internet access to objectionable content (e.g., pornography).

The caching services of the system 500 may be utilized to target the customer whose usage is reaching the maximum capacity of their existing terrestrial Internet connection. By deploying an intelligent caching service, the cache engine reduces utilization across the existing infrastructure to allow the customer to leverage the existing infrastructure for a longer period of time. The intelligent caching service may also backup the existing terrestrial Internet connection in the event of an outage by providing an alternate path to the Internet/Intranet; e.g., when existing terrestrial Internet connection is cut, access is restored across a two-satellite network.

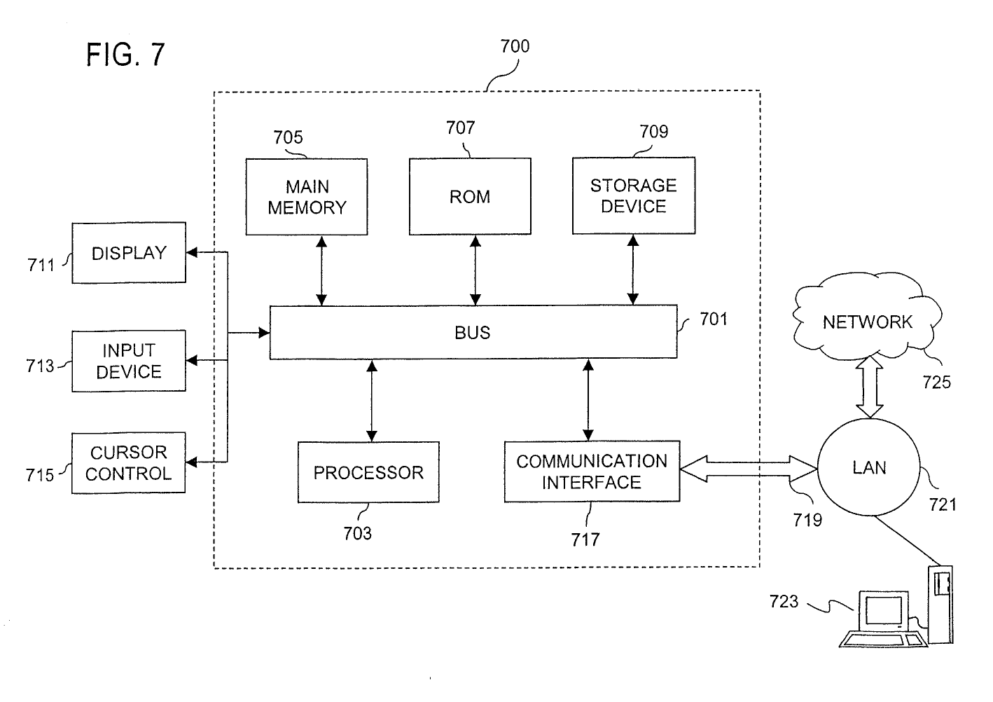

FIG. 7 illustrates a computer system 700 upon which an embodiment according to the present invention can be implemented. The computer system 700 includes a bus 701 or other communication mechanism for communicating information, and a processor 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions to be executed by the processor 703. The computer system 700 further includes a read only memory (ROM) 707 or other static storage device coupled to the bus 701 for storing static information and instructions for the processor 703. A storage device 709, such as a magnetic disk or optical disk, is additionally coupled to the bus 701 for storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is cursor control 715, such as a mouse, a trackball, or cursor direction keys for communicating direction information and command selections to the processor 703 and for controlling cursor movement on the display 711.

According to one embodiment of the invention, the content popular analysis is provided by the computer system 700 in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the present invention. Thus, embodiments of the present invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, or a telephone modem to provide a data communication connection to a corresponding type of telephone line. As another example, communication interface 717 maybe a local area network (LAN) card (e.g. for Ethernet™ or an Asynchronous Transfer Model (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by service provider. The local network 721 and network 725 both use electrical, electromagnetic, or optical signals to convey information and instructions. The signals through the various networks and the signals on network link 719 and through communication interface 717, which communicate digital data with computer system 700, are exemplary forms of carrier waves bearing the information and instructions.

The computer system 700 can send messages and receive data, including program code, through the network(s), network link 719, and communication interface 717. In the Internet example, a server (not shown) might transmit requested code belonging an application program for implementing an embodiment of the present invention through the network 725, local network 721 and communication interface 717. The processor 704 may execute the transmitted code while being received and/or store the code in storage device 79, or other non-volatile storage for later execution. In this manner, computer system 700 may obtain application code in the form of a carrier wave.

The term “computer-readable medium” as used herein refers to any medium that participates in providing instructions to the processor 704 for execution. Such a medium may take many forms, including but not limited to non-volatile media, volatile media, and transmission media. Non-volatile media include, for example, optical or magnetic disks, such as storage device 709. Volatile media include dynamic memory, such as main memory 705. Transmission media include coaxial cables, copper wire and fiber optics, including the wires that comprise bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistance (PDA) and a laptop. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

Accordingly, a caching mechanism includes a central cache that distributes a master content list to one or more remote cache engines. Each of the remote cache engines provides analysis of the content that is accessed by the particular cache engine; the analysis, in turn, is sent to a master cache. In an exemplary embodiment, the analysis is used to order the content according to the degree of popularity. The master cache, in turn, conducts an analysis of the contents from all of the remote cache engines to generate the master profile. According to one embodiment of the present invention, the content associated with the master profile is pre-loaded in the remote cache engines using multicast over a satellite network.

While the present invention has been described in connection with a number of embodiments and implementations, the present invention is not so limited but covers various obvious modifications and equivalent arrangements, which fall within the purview of the appended claims.

What is claimed is:

1. A method for providing intelligent caching, the method comprising:
analyzing a traffic stream for content;
outputting a profile of the content based upon the analyzing step, wherein the profile is used to prepare a master profile; and
caching content that is associated with the master profile.

2. The method of claim 1, further comprising:
receiving the content associated with the master profile over a wide area network (WAN).

3. The method of claim 2, wherein the WAN is a satellite network that supports a multicast communications session.

4. The method of claim 1, wherein the caching step is executed to pre-load a cache.

5. The method of claim 4, further comprising:
periodically refreshing the cache with content of a new master profile.

6. The method of claim 1, wherein the outputting step comprises:
prioritizing the content based upon popularity.

7. The method of claim 1, further comprising:
restricting access only to content that is associated with the master profile.

8. The method of claim 1, wherein the profile in the outputting step is categorized according to predetermined content communities.

9. A method for providing intelligent caching, the method comprising:
receiving a profile that is prepared based upon content of a traffic stream;
generating a master profile based upon the received profile; and
transmitting content associated with the master profile to a remote cache.

10. The method of claim 9, wherein the content associated with the master profile is transmitted over a wide area network (WAN).

11. The method of claim 10, wherein the WAN is a satellite network that supports a multicast communications session.

12. The method of claim 9, wherein the master content associated with the master profile is pre-loaded in the remote cache.

13. The method of claim 9, further comprising:
generating a new master profile; and
periodically refreshing the remote cache with content associated with the new master profile.

14. The method of claim 9, wherein the generating step comprises:
prioritizing the content based upon popularity.

15. The method of claim 9, wherein the master profile is used to restrict access to content.

16. A communications system for providing intelligent caching, the system comprising:
a first caching logic configured to analyze a traffic stream for content and to output a first profile of the content; and
a second caching logic configured to generate a second profile based upon the first profile, wherein the second profile is used to retrieve content.

17. The system of claim 16, wherein the content associated with the second profile is transmitted over a wide area network to a remote cache.

18. The system of claim 17, wherein the WAN is a satellite network that supports a multicast communications session.

19. The system of claim 17, wherein the remote cache is pre-loaded with the content associated with the second profile.

20. The system of claim 17, wherein the remote cache is periodically refreshed with content associated with a new master profile.

21. The system of claim 16, wherein the content of the first profile and the content associated with the second profile are prioritized based upon popularity.

22. The system of claim 16, wherein the second profile is used to restrict access to content.

23. The system of claim 16, wherein the first profile is categorized according to predetermined content communities.

24. A network device for providing intelligent caching services, comprising:
a processor configured to analyze a traffic stream for content and to output a profile of the content, wherein the profile is used to prepare a master profile; and
a cache coupled to the processor and configured to store content that is associated with the master profile.

25. The device of claim 24, further comprising:
a communications interface configured to receive the content associated with the master profile over a wide area network (WAN).

26. The device of claim 25, wherein the WAN is a satellite network that supports a multicast communications session.

27. The device of claim 24, wherein the cache is pre-loaded with the content that is associated with the master profile.

28. The device of claim 27, wherein the cache is periodically refreshed with content of a new master profile.

29. The device of claim 24, wherein the content of the profile and the content associated with the master profile are prioritized based upon popularity.

30. The device of claim 24, wherein the processor is further configured to restrict access only to content that is associated with the master profile.

31. The device of claim 24, wherein the profile is categorized according to predetermined content communities.

32. A network device for providing intelligent caching, the device comprising:
a communications interface configured to receive a profile that is prepared based upon content of a traffic stream; and
a processor coupled to the communications interface and configured to generate a master profile based upon the received profile, wherein the content associated with the master profile is transmitted over the communications interface to a remote cache.

33. The device of claim 32, wherein the communications interface is configured to interface with a wide area network (WAN).

34. The device of claim 33, wherein the WAN is a satellite network that supports a multicast communications session.

35. The device of claim 32, the content associated with the master profile is pre-load in the remote cache.

36. The device of claim 32, wherein the processor is further configured to generate a new master profile, the remote cache being periodically refreshed with content associated with the new master profile.

37. The device of claim 32, wherein the content of the profile and the content associated with the master profile are prioritized based upon popularity.

38. The device of claim 32, wherein the master profile is used to restrict access to content.

39. A network apparatus for providing intelligent caching, the apparatus comprising:
means for analyzing a traffic stream for content;
means for outputting a profile of the content, wherein the profile is used to prepare a master profile; and
means for caching content that is associated with the master profile.

40. The apparatus of claim 39, further comprising:
means for receiving the content associated with the master profile over a wide area network (WAN).

41. The apparatus of claim 40, wherein the WAN is a satellite network that supports a multicast communications session.

42. The apparatus of claim 39, wherein the caching means is pre-loaded with the content that is associated with the master profile.

43. The apparatus of claim 42, further comprising:
means for periodically refreshing the caching means with content of a new master profile.

44. The apparatus of claim 39, further comprising:
means for prioritizing the content based upon popularity.

45. The apparatus of claim 39, further comprising:
means for restricting access only to content that is associated with the master profile.

46. The apparatus of claim 39, wherein the profile is categorized according to predetermined content communities.

47. A computer-readable medium carrying one or more sequences of one or more instructions for providing intelligent caching, the one or more sequences of one or more instructions including instructions which, when executed by one or more processors, cause the one or more processors to perform the steps of:
analyzing a traffic stream for content;
outputting a profile of the content based upon the analyzing step, wherein the profile is used to prepare a master profile; and
caching content that is associated with the master profile.

48. The computer-readable medium of claim 47, further comprising computer-executable instructions for causing the one or more processors to perform the step of:
receiving the content associated with the master profile over a wide area network (WAN).

49. The computer-readable medium of claim 48, wherein the WAN is a satellite network that supports a multicast communications session.

50. The computer-readable medium of claim 47, wherein the caching step is executed to pre-load a cache.

51. The computer-readable medium of claim 50, further comprising computer-executable instructions for causing the one or more processors to perform the step of:
periodically refreshing the cache with content of a new master profile.

52. The computer-readable medium of claim 47, wherein the outputting step comprises:
prioritizing the content based upon popularity.

53. The computer-readable medium of claim 47, further comprising computer-executable instructions for causing the one or more processors to perform the step of:
restricting access only to content that is associated with the master profile.

54. The computer-readable medium of claim 47, wherein the profile in the outputting step is categorized according to predetermined content communities.

55. A computer-readable medium carrying one or more sequences of one or more instructions for providing intelligent caching, the one or more sequences of one or more instructions including instructions which, when executed by one or more processors, cause the one or more processors to perform the steps of:
receiving a profile that is prepared based upon content of a traffic stream;
generating a master profile based upon the received profile; and
transmitting content associated with the master profile to a remote cache.

56. The computer-readable medium of claim 55, wherein the content associated with the master profile is transmitted over a wide area network (WAN).

57. The computer-readable medium of claim 56, wherein the WAN is a satellite network that supports a multicast communications session.

58. The computer-readable medium of claim 55, wherein the master content associated with the master profile is pre-loaded in the remote cache.

59. The computer-readable medium of claim 55, further comprising computer-executable instructions for causing the one or more processors to perform the steps of:
generating a new master profile; and
periodically refreshing the remote cache with content associated with the new master profile.

60. The computer-readable medium of claim 55, wherein the generating step comprises:
prioritizing the content based upon popularity.

61. The computer-readable medium of claim 55, wherein the master profile is used to restrict access to content.
